(19) United States
(12) Patent Application Publication
(10) Pub. No.: US 2025/0332568 A1
(43) Pub. Date: Oct. 30, 2025

(54) FORMALDEHYDE-SCAVENGING FORMULATION

(71) Applicant: Owens Corning Intellectual Capital, LLC, Toledo, OH (US)

(72) Inventors: Paul A. Geel, Heveadorp (NL); Camille Rouillon, Bassens (FR); Bert Van Cuijk, Apeldoorn (NL)

(21) Appl. No.: 18/860,802

(22) PCT Filed: May 16, 2023
(86) PCT No.: PCT/IB2023/055030

§ 371 Date: Oct. 28, 2024

(30) Foreign Application Priority Data
May 16, 2022 (EP) 22173637.4

(51) Int. Cl. B01J 20/26; B01J 20/28

(52) U.S. Cl. CPC B01J 20/261; B01J 20/2803; B01J 20/28035

(57) ABSTRACT

The present invention is concerned with improved formaldehyde-scavenging formulations, and uses of same in veils and construction products including ceiling tiles, boards including insulation boards, particularly phenolic insulation boards, and panels and boards including wood panels and wood boards, together with methods for reduction of formaldehyde emissions from a construction product.

### FIELD OF THE INVENTION

The present invention is concerned with improved formaldehyde-scavenging formulations, and uses of same. Particular uses include in veils (particularly non-woven veils) and construction products including ceiling tiles, boards including insulation boards, particularly phenolic insulation boards, and panels and boards including wood-based panels, fabrics, textiles, and on or applied to other substrates. Also disclosed are methods for reduction of formaldehyde emissions from a construction product.

### BACKGROUND TO THE INVENTION

Formaldehyde has a high potential toxicity and is an irritant that may cause allergic reactions and other health issues, including irritation of the skin, of the respiratory tract or of the eyes in humans. The publication “WHO Guidelines for Indoor Air Quality: Selected Pollutants” (World Health Organization, 2010, ISBN 978 92 890 0213 4, pp. 103-156) further details the health impact of formaldehyde. Golden, R. (Crit Rev Toxicol. 2011 September; 41(8): 672-721; doi: 10.3109/10408444.2011.573467; PMID: 21635194) provides a recommendation for an indoor air exposure limit for formaldehyde.

Emission standards are set by various national laws, including French law Décret n° 2011-321 (published 25 Mar. 2011). Emissions classes in France are defined in the JOURNAL OFFICIEL DE LA RÉPUBLIQUE FRANçAISE, JORF no 0111, 13 May 2011, NOR: DEVL1104875A at Annex I.D-the “Arrêté étiquetage 2011”. Class “A+” for VOC (volatile organic compounds) emissions includes a requirement for <10 ug/m\hat{ }3 of formaldehyde emissions in 28 days. Class “A” for VOC emissions includes a requirement for <60 ug/m\hat{ }3 of formaldehyde emissions in 28 days.

Formaldehyde emissions from construction products therefore have to be controlled/reduced in order to minimise health risk and comply with standards. The reduction of formaldehyde emissions from construction products is therefore important.

It is also highly desirable that any new or improved formaldehyde-scavenging agent or composition (i.e. formulation) (i) does not itself present additional environmental or health and safety concerns, including in a manufacturing environment, and (ii) is compatible with existing construction product manufacturing protocols and process conditions so that a switch of formaldehyde-scavenging agent or composition (i.e. formulation) can be made without having to modify existing construction product manufacturing protocols and process conditions.

Furthermore, agglomeration of components in formulations is undesirable and inconvenient, yet is observed to occur in various formaldehyde scavenger formulations. It is desirable to reduce, minimise or avoid agglomeration entirely since it can have undesired effects. In particular, it can e.g. result in clogged filters when they are used as part of the manufacturing process. Similarly, agglomeration can result in undesirable textural effects/lumps in the final product.

Publications include WO 2012/076489 A1, WO 2006/104455 A1, WO 2015/041791 A1, and WO 2016/009054 A1.

The present inventors have found that use of anionic stabilized binders and anionic stabilized fire retardants (e.g. Aluminum TriHydrate (ATH) slurries stabilized with anionic dispersants) in combination with cationic scavengers such as polyvinylamine (PVAm) that are in the form of NH₃⁺ can in particular result in agglomeration.

The present invention seeks to overcome one or more of the prior art disadvantages and provide improved formaldehyde-scavenging formulation.

In the below description, all ranges include the lower and upper limits. The singular is understood to also mean the plural form.

### SUMMARY OF THE INVENTION

According to the present invention there is provided a formaldehyde-scavenging formulation comprising:
(a) a polyvinylamine (PVAm) formaldehyde scavenger or a copolymer thereof;
(b) optionally a non-ionic or cationic stabilized binder and/or crosslinker; and
(c) a non-ionic stabilized fire retardant.

In certain embodiments, the formulation comprises 1-90% by weight dry mass PVAm scavenger or a copolymer thereof.

In certain embodiments, the formulation comprises 1 to 60% by weight dry mass of a non-ionic or cationic stabilized binder and/or crosslinker.

In certain embodiments, the formulation comprises <=96% by weight dry mass of a non-ionic stabilized fire retardant. In certain embodiments, the formulation comprises 1-96% by weight dry mass of a non-ionic stabilized fire retardant. In certain embodiments, the formulation comprises 10-90% of a non-ionic stabilized fire retardant.

According to a preferred first embodiment, the formaldehyde-scavenging formulation comprises:
(a) 1 to 90% by weight dry mass of a polyvinylamine (PVAm) formaldehyde scavenger or a copolymer thereof;
(b) 0 to 60%, preferably 1 to 60% by weight dry mass of a non-ionic or cationic stabilized binder and/or crosslinker; and
(c) 10 to 90% of a non-ionic stabilized fire retardant.

### PVAm Formaldehyde Scavenger or Copolymer Thereof

In certain embodiments, the polyvinylamine (PVAm) or the copolymer thereof has a weight average molecular weight (Mw) in the range 50,000-800,000 g/mol. In certain embodiments, it is in the range 200,000-600,000 g/mol. In certain embodiments, it is in the range 300,000-500,000 g/mol. In certain embodiments, it is in the range 350,000-450,000 g/mol. In certain embodiments, it is approximately 400,000 g/mol. The weight average molecular weight (Mw) is measured by Size exclusion chromatography.

In certain embodiments, the percentage dry weight of the polyvinylamine or the copolymer thereof is in the range 1-90%, advantageously in the range 1-60%. In certain embodiments, it is in the range 1-45%. In certain embodiments, it is in the range 1-30%. In other embodiments, it is in the range 5-25%. In certain embodiments, it is in the range 6-20%. In certain embodiments, it is in the range 7-15%. In other embodiments, it is in the range 10-20%. In certain embodiments, it is in the range 2-11%. In some embodiments, it is in the range 2.5-7%. In some embodiments, it is in the range 3-5%.

The polyvinylamine may be present in forms other than a pure polyvinylamine. It may, for example, be present in the form of a copolymer, for example a polyvinylamine-polyvinyl alcohol (PVAm-PVOH) copolymer. Other copolymers include PVAm-PVF (polyvinylamine-polyvinylformamide) copolymers.

The polyvinylamine or copolymer thereof are advantageously in their cationic form, which means that they have part or all their amine functions in the form of NH₃^{+.} Counter ion can be C⁻, or any other equivalent counter ion. The pH of the polyvinylamine or copolymer thereof is advantageously around 8 at 25DegC in water.

### Binder and/or Crosslinker

As detailed above, the binder and/or crosslinker is a non-ionic or cationic stabilized binder and/or crosslinker.

By “non-ionic or cationic stabilized” it is understood that the binder and/or the crosslinker is in the form of an emulsion or a dispersion in water, said emulsion or dispersion containing a non-ionic or cationic surfactant. The non-ionic or cationic surfactant that can be selected from the group consisting of: polyoxyethylenatedalkylphenol, monoglycerides of long chain fatty acids, polyoxyethylenated alcohol, quarternary ammonium compounds, trimethylalkylammonium chloride, benzalkonium chloride. In certain embodiments, it is polyoxyethylenated alcohol.

A binder is generally not reactive towards the other chemical elements of the formulation, it is used to bond the mineral fillers to the glass into the veil.

A crosslinker is reactive towards at least one other element of the formulation and/or the glass. It is helpful in some cases to increase the dimensional stability of the veil and may have a scavenging functionality as well.

In certain embodiments, the non-ionic or cationic stabilized binder and/or crosslinker is a non-ionic or cationic stabilized binder. In certain embodiments, it is a non-ionic stabilized binder.

Suitable examples of non-ionic stabilized binders include self-crosslinking dispersions of Vinyl Acetate Ethylene (VAE), acrylic binders, or polyurethanes.

Other suitable binders include cationic stabilized acrylic binders such as cationic dispersions of a copolymer from acrylic acid esters. Other suitable binders and crosslinkers will be readily apparent to one of ordinary skill in the art, provided they are cationic or non-ionic stabilized.

In certain embodiments, the non-ionic or cationic stabilized binder and/or crosslinker is a binder, the percentage dry weight of binder being lower or equal to 60%, that is to say 0 to 60%, preferably in the range 1-60%. In certain such embodiments, the percentage dry weight of binder is in the range 1-40%.

In other such embodiments, it is in the range 2-30%. In other such embodiments, it is in the range 3-20%. In other such embodiments, it is in the range 4-20%. In other such embodiments, it is in the range 5-10%.

In alternative embodiments, the non-ionic or cationic stabilized binder and/or crosslinker is in the form of a crosslinker, the percentage dry weight of crosslinker being in the range 0-30%, preferably 1-30%. In certain such embodiments, it is in the range 2-20%. In other such embodiments, it is in the range 3-15%. In other such embodiments, it is in the range 4-10%. In further embodiments, it is in the range 5-9%. In further embodiments, it is in the range 6-8%.

Suitable examples of crosslinkers include: polyacrylic acid, carbodiimide, epoxy compound, isocyanates, silanes, dialdehydes.

For the specific case of the crosslinker, it can be used without any stabilizer, as such or in the form of a solution in water in the formulation, provided it is by itself cationic or non-ionic.

In some embodiments, both binder and crosslinker are present. In certain embodiments, the total percentage dry weight of binder and crosslinker is in the range 1-30%. In certain such embodiments, it is in the range 2-20%. In other such embodiments, it is in the range 3-15%. In other such embodiments, it is in the range 4-10%. In further embodiments, it is in the range 5-9%. In further embodiments, it is in the range 6-8%. The dry weight ratio of binder to crosslinker in certain embodiments is in the range 2:1 to 20:1. In certain embodiments, the ratio is in the range 5:1 to 15:1. In other embodiments, the ratio is in the range 8:1 to 12:1. In particular embodiments, the ratio is approximately 10:1.

### Non-Ionic Stabilized Fire Retardant

By “non-ionic stabilized fire retardant”, it should be understood that the fire retardant is in the form of a slurry or dispersion in water in the presence of a non-ionic dispersant.

The non-ionic dispersant can be selected from the group consisting of: polyoxyethylenatedalkylphenol, monoglycerides of long chain fatty acids, and polyoxyethylenated alcohol. In certain embodiments, it is polyoxyethylenated alcohol.

In certain embodiments, the non-ionic stabilized fire retardant (also referred to as a “flame retardant”) is selected from the group consisting of a non-ionic stabilized aluminium trihydrate (ATH) (Al(OH)₃), non-ionic stabilized phosphorous-nitrogen, non-ionic stabilized magnesium oxide (MgO), non-ionic stabilized magnesium hydroxide (Mg(OH)₂). Non-ionic stabilized ATH is the preferred fire retardant.

In certain embodiments, the non-ionic stabilized fire retardant, preferably the ATH, is in the form of a slurry.

Slurry form is preferred because it is easier to handle compared to a powder for safety reasons.

In certain embodiments, the percentage dry weight of non-ionic stabilized fire retardant is lower or equal to 96%. In certain embodiments, it is in the range 1-96%. In certain embodiments, it is in the range 10-95%. In certain embodiments, it is in the range 10-90%. In certain embodiments, it is in the range 20-90%. In certain embodiments, it is in the range 30-85%. In certain embodiments, it is in the range 40-80%. In certain embodiments, it is in the range 50-75%. In certain embodiments, it is in the range 60-70%.

The total percentage dry weight of the fire retardant and PVAm formaldehyde scavenger may be at least 50%. In certain embodiments, it is at least 60%. In other embodiments, it is at least 70%. In further embodiments, it is at least 80%. In certain embodiments, it is at least 90%. In other embodiments, it is at least 95%. In certain embodiments, it is at least 96%.

In certain embodiments, the total percentage dry weight of the fire retardant and PVAm formaldehyde scavenger is between 50% and 95%. In certain embodiments, it is between 60% and 90%. In certain embodiments, it is between 70% and 85%.

In certain embodiments, the dry weight ratio of the fire retardant to PVAm formaldehyde scavenger is at least 2:1. In certain embodiments, it is at least 3:1. In certain embodiments, it is at least 4:1. In certain embodiments, it is at least 5:1. In certain embodiments, it is between 4:1 and 15:1. In certain embodiments, it is between 6:1 and 10:1. In certain embodiments, it is between 7:1 and 9:1.

### Antifoaming Agent

In certain embodiments, the formulation additionally comprises an antifoaming agent. Antifoaming agents are well known in the art. Suitable antifoaming agents include (but are not limited to) silicone based antifoaming emulsions and those based on polydimethylsiloxane (PDMS) oils and emulsions. Other suitable antifoaming agents are mineral oils and silicon free polymer defoamers. Thus, in certain embodiments, the antifoaming agent is an antifoaming agent emulsion (i.e. is an emulsion). The antifoaming agent emulsion can be non-ionic stabilized. In particular, the antifoaming agent emulsion can comprise a non-ionic emulsifier.

In certain embodiments, the formulation comprises <=1.5% by weight dry mass of antifoaming agent. In certain embodiments, it comprises <=1% by weight dry mass. In certain embodiments, it comprises <=0.5% by weight dry mass of antifoaming agent. In certain embodiments, it comprises between 0.01% and 1.5% by weight dry mass of antifoaming agent.

In certain embodiments, there is <=0.1% by weight dry mass of antifoaming agent present. In certain embodiments, there is <=0.05% by weight dry mass of antifoaming agent.

In certain embodiments, the amount of antifoaming agent is >=0.001% and <0.1% by weight dry mass.

In certain embodiments, the amount of antifoaming agent is >=0.01% and <0.1% by weight dry mass. In certain embodiments, the amount of antifoaming agent is >=0.01% and <=0.05% by weight dry mass. In certain embodiments, there is between 0.01% and 0.02% by weight dry mass antifoaming agent.

### Repellent Agent

In certain embodiments, the formulation additionally comprises a repellent agent. Suitable repellents include cationic repellents, for example non-fluorinated cationic water emulsions such as acrylic based repellent agents, silicon-type repellent agents and waxes. Thus, in certain embodiments the repellent agent is cationic. In other embodiments, the repellent is non-ionic. Thus, in certain embodiments the repellent is non-ionic or cationic. Other repellents include (but are not limited to) fluorocarbons and perfluoroalkyl-functionalized acrylates.

In certain embodiments, the formulation comprises <=20% by weight dry mass of repellent agent. In certain embodiments, it comprises 1-20% by weight dry mass of repellent agent. In certain embodiments, it comprises 1-15% by weight dry mass of repellent agent. In certain embodiments, it comprises 1-10% by weight dry mass of repellent agent. In certain embodiments, it comprises 2-20% by weight dry mass of repellent agent.

### Aminosilane

The formulation can additionally comprise a coupling agent, notably an aminosilane. Coupling agents give improved hot wet resistance to the veil. Aminosilanes include primary aminosilanes, i.e. primary amine functionalised silanes. Examples include aminoalkyl silanes. An exemplary aminosilane is gamma-aminopropyltriethoxysilane (H₂NCH₂CH₂CH₂Si(OCH₂CH₃)₃).

In certain embodiments, the formulation comprises <=30% by weight dry mass of aminosilane. In certain embodiments, the formulation comprises between 1 and 30% by weight dry mass of aminosilane. In certain embodiments, the formulation comprises between 2 and 20% by weight dry mass of aminosilane. In certain embodiments, the formulation comprises between 3 and 15% by weight dry mass of aminosilane. In certain embodiments, the formulation comprises between 4 and 10% by weight dry mass of aminosilane.

### Pigment

In certain embodiments, the formulation additionally comprises a pigment. In particular embodiments, it comprises <=5% by weight dry mass of pigment. In certain embodiments, it comprises 0.1-5% by weight dry mass of pigment. In certain embodiments, it comprises between 0.5 and 4.5% by weight dry mass of pigment. In certain embodiments, it comprises between 1 and 4% by weight dry mass of pigment. In certain embodiments, it comprises between 1.5 and 3.0% by weight dry mass of pigment.

Pigment can be particularly useful to hide or mask discoloration resulting from e.g. heat impact from subsequent processing/use of the formulation. Pigments can be organic or inorganic pigments, preferably organic, notably carbon black. For example, a black pigment is used in certain embodiments to hide discoloration resulting from subsequent heating of the formulation.

The formulation may optionally additionally comprise one or more of (i.e. at least one of):
(A) dispersing agent;
(B) viscosity modifier; and
(C) polyphosphate salts of formula —[MPO₃]—ₙ(OH)₂ wherein M is selected from the group consisting of Na, K, and NH₄, and wherein n is an integer greater than 100, preferably greater than 1000.

In certain embodiments, the formulation comprises a dispersing agent (0-3% by weight dry mass). Suitable dispersing agents include (but are not limited to) polycarboxylic acid dispersants, particularly salt solutions such as sodium salt solutions of polycarboxylic acid dispersants. In certain embodiments, the formulation comprises 0.1-3% by weight dry mass dispersing agent.

In certain embodiments, the formulation comprises a viscosity modifier (0-5% by weight dry mass). In certain embodiments, the formulation comprises 0.1-5% by weight dry mass viscosity modifier.

In certain embodiments, the polyphosphate salts are polyphosphate ammonium salts.

In certain embodiments, the formulation comprises polyphosphate sodium salts (0-20% by weight dry mass).

In certain embodiments, the formulation comprises polyphosphate ammonium salts (0-20% by weight dry mass). In certain embodiments, the formulation comprises polyphosphate ammonium salts (0.1-20% by weight dry mass). In certain embodiments, the formulation comprises polyphosphate ammonium salts (1=20% by weight dry mass. In certain embodiments, n>1000.

The formaldehyde-scavenging formulation is typically an aqueous formulation.

### Base

In certain embodiments, the formulation additionally comprises base. Suitable bases will be readily apparent to one of ordinary skill in the art and include (but are not limited to) Ca(OH)₂, NaOH, KOH, Na₂CO₃, Mg(OH)₂, and Na₃PO₄. A particular preferred base is sodium carbonate (Na₂CO₃). The base can be introduced to adjust pH of the formulation, if needed, to avoid agglomeration issues, but in an amount that is not causing corrosion to the equipment.

In certain embodiments, the percentage dry weight of base is <=50%. In certain embodiments, it is in the range 0-25%, i.e. <=25%.

In other embodiments, the percentage dry weight of base is in the range 0.5-25%.

In other embodiments, the percentage dry weight of base is in the range 1-20%. In other embodiments, it is in the range 1.5-15%.

In embodiments comprising base, the dry weight ratio of polyvinylamine or copolymer thereof to base may be in the range 1:3 to 3:1. It may be in the range 1:2 to 2:1. It may be in the range 1:1 to 2:1.

Thus, in certain embodiments, the formaldehyde-scavenging formulation comprises:
A polyvinylamine (PVAm) formaldehyde scavenger (1-90% by weight dry mass);
a non-ionic stabilized binder and/or crosslinker (<=60% by weight dry mass); and
a non-ionic stabilized aluminium trihydrate (ATH) fire retardant (<=96% by weight dry mass); and
   additionally comprising:
an antifoaming agent (<=1% by weight dry mass); and
a repellent agent (<=20% by weight dry mass); and
an aminosilane.

### Second Aspect

According to a second aspect of the present invention, there is provided a formaldehyde-scavenging formulation comprising:
(a) polyvinylamine (PVAm) formaldehyde scavenger or a copolymer thereof; and
(b) antifoaming agent (<=1.0% by weight dry mass).

In certain embodiments, the formulation does not comprise binder and/or crosslinker. In certain embodiments, it does not comprise non-ionic or cationic stabilized binder and/or crosslinker.

In certain embodiments, the formulation does not comprise fire retardant. In particular embodiments, it does not comprise non-ionic stabilized fire retardant.

### PVAm or Copolymer Thereof Formaldehyde Scavenger

As discussed previously, in certain embodiments the polyvinylamine (PVAm) has a weight average molecular weight (Mw) in the range 50,000-800,000 g/mol. In certain embodiments, it is in the range 200,000-600,000 g/mol. In certain embodiments, it is in the range 300,000-500,000 g/mol. In certain embodiments, it is in the range 350,000-450,000 g/mol. In certain embodiments, it is approximately 400,000 g/mol.

The polyvinylamine may be present in forms other than a pure polyvinylamine. It may, for example, be present in the form of a copolymer, for example a polyvinylamine-polyvinyl alcohol (PVAm-PVOH) copolymer. Other copolymers include PVAm-PVF (polyvinylamine-polyvinylformamide) copolymers.

The polyvinylamine or copolymer thereof are advantageously in their cationic form, which means that they have part or all their amine functions in the form of NH₃⁺. Counter ion can be Cl⁻, or any other equivalent counter ion. The pH of the polyvinylamine or copolymer thereof is advantageously around 8 at 25DegC in water.

### Antifoaming Agent

As detailed above, antifoaming agents are well known in the art. Suitable antifoaming agents include (but are not limited to) silicone-based antifoaming emulsions and those based on polydimethylsiloxane (PDMS) oils and emulsions. The antifoaming agent can be non-ionic. In particular, the antifoaming agent can comprise a non-ionic emulsifier.

Other suitable antifoaming agents are mineral oils and silicon free polymer defoamers. Thus, in certain embodiments, the antifoaming agent is an antifoaming agent emulsion (i.e. is an emulsion). The antifoaming agent emulsion can be non-ionic stabilized. In particular, the antifoaming agent emulsion can comprise a non-ionic emulsifier.

As noted previously, the present inventors have found that use of anionic species in combination with cationic scavengers such as PVAm can in particular result in agglomeration. Thus, the use of non-ionic or cationic components is particularly desirable in the prevention of agglomeration.

In certain embodiments, the formulation comprises <=0.5% by weight dry mass antifoaming agent. In certain embodiments, it comprises between 0.001% and 1.5% by weight dry mass antifoaming agent.

In certain embodiments, there is <=0.1% by weight dry mass antifoaming agent present. In certain embodiments, there is <=0.05% by weight dry mass antifoaming agent. In certain embodiments, the amount of antifoaming agent is >=0.001% and <=0.1% by weight dry mass. In certain embodiments, the amount of antifoaming agent is >=0.01% and <=0.1% by weight dry mass. In certain embodiments, the amount of antifoaming agent is >=0.01% and <=0.05% by weight dry mass. In certain embodiments, there is between 0.01% and 0.02% by weight dry mass antifoaming agent.

### Pigment

In certain embodiment, the formulation additionally comprises pigment. In certain embodiments, the formulation additionally comprises <=5% by weight dry mass of pigment. In certain embodiments, it comprises 0.1-5% by weight dry mass of pigment. In certain embodiments, it comprises between 0.5 and 4.5% by weight dry mass of pigment. In certain embodiments, it comprises between 1 and 4% by weight dry mass of pigment. In certain embodiments, it comprises between 1.5 and 3.0% by weight dry mass of pigment.

### Non-Ionic Stabilized Fire Retardant

In certain embodiments, the formulation additionally comprises non-ionic stabilized fire retardant (<=96% by weight dry mass) in the form of a slurry or dispersion in water in the presence of a non-ionic dispersant.

The non-ionic dispersant can be selected from the group consisting of: polyoxyethylenatedalkylphenol, monoglycerides of long chain fatty acids, and polyoxyethylenated alcohol. In certain embodiments, it is polyoxyethylenated alcohol.

As per the first aspect, in certain embodiments, the non-ionic stabilized fire retardant (also referred to as a “flame retardant”) is selected from the group consisting of a non-ionic stabilized aluminium trihydrate (ATH) (Al(OH)₃), non-ionic stabilized phosphorous-nitrogen, non-ionic stabilized magnesium oxide (MgO), non-ionic stabilized magnesium hydroxide (Mg(OH)₂). Non-ionic stabilized ATH is the preferred fire retardant.

In certain embodiments, the non-ionic stabilized fire retardant, preferably the ATH, is in the form of a slurry.

In certain embodiments, the percentage dry weight of non-ionic stabilized fire retardant is in the range 10-95%. In certain embodiments, it is in the range 20-90%. In certain embodiments, it is in the range 30-85%. In certain embodiments, it is in the range 40-80%. In certain embodiments, it is in the range 50-75%. In certain embodiments, it is in the range 60-75%.

### PVAm Formaldehyde Scavenger

In certain embodiments, the formulation comprises >=10% by weight dry mass PVAm formaldehyde scavenger or a copolymer thereof.

In certain embodiments, it comprises >=15% by weight dry mass PVAm formaldehyde scavenger or a copolymer thereof. In certain embodiments, it comprises >=20% by weight dry mass formaldehyde scavenger or a copolymer thereof. In certain embodiments, it comprises >=25% by weight dry mass formaldehyde scavenger or a copolymer thereof.

As per the first aspect, the polyvinylamine may be present in forms other than a pure polyvinylamine. It may, for example, be present in the form of a copolymer, for example a polyvinylamine-polyvinyl alcohol (PVAm-PVOH) copolymer. Other copolymers include PVAm-PVF (polyvinylamine-polyvinylformamide) copolymers.

The polyvinylamine or copolymer thereof are advantageously in their cationic form, which means that they have part or all their amine functions in the form of NH₃⁺. Counter ion can be Cl⁻, or any other equivalent counter ion. The pH of the polyvinylamine or copolymer thereof is advantageously around 8 at 25DegC in water.

### Binder and/or Crosslinker

In certain embodiments, the formulation additionally comprises non-ionic or cationic stabilized binder and/or crosslinker (<=60% by weight dry mass). Options for the non-ionic or cationic stabilized binder and/or crosslinker are as previously discussed for the first aspect.

### Repellent Agent

In certain embodiments, the formulation additionally comprises repellent agent. Options for the repellent agent are as previously discussed for the first aspect.

### Aminosilane

In certain embodiments, the formulation additionally comprises aminosilane. Options for the aminosilane are as previously discussed for the first aspect.

In certain embodiments, the formulation additionally comprises one or more of (i.e. at least one of):
(A) dispersing agent;
(B) viscosity modifier; and
(C) polyphosphate salts of formula —[MPO₃]—ₙ(OH)₂ wherein M is selected from the group consisting of Na, K, and NH₄, and wherein n is an integer greater than 100, preferably greater than 1000.

Options for these are as previously discussed for the first aspect.

The formaldehyde-scavenging formulation is typically an aqueous formulation.

### Base

In certain embodiments, the formulation additionally comprises base. Options for this are as previously discussed for the first aspect.

### Uses

The formaldehyde scavenging formulations of the present invention can be used in (e.g. applied to or contained in) veils (particularly non-woven, NW, veils) and construction products including ceiling tiles, boards including insulation boards, particularly phenolic insulation boards, and panels and boards including wood based panels, fabrics, textiles, and on or applied to other substrates.

### Veils

Also provided according to the present invention is a non-woven veil coated with or containing a formaldehyde-scavenging formulation according to the present invention.

Non-woven veils for construction products are well known in the art, and typically comprise intermingled, randomly oriented reinforcing fibres. The fibre component of a veil may be any of metal fibres, ceramic fibres, mineral fibres, glass fibres, carbon fibres, graphite fibres, polymer fibres, such as aramid, polyesters, polyacrylics, polyamides, polyacrylonitrile, natural fibres and combinations thereof. In particular, the fibre component of the veil may be glass fibres. The veil may comprise 20-130 g/m\hat{ }2 of fibres.

The veil may comprise up to 40 g/m\hat{ }2 of formaldehyde scavenger. It may comprise 0.5-20 g/m\hat{ }2 of formaldehyde scavenger. It may comprise 1-15 g/m\hat{ }2 of formaldehyde scavenger. It may comprise 2-10 g/m\hat{ }2 of formaldehyde scavenger. It may comprise 3-6 g/m\hat{ }2 of the formaldehyde scavenger. As detailed in the examples below, excellent results have been achieved with these quantities of formaldehyde scavenger.

In particular, the veil may comprise 5-250 g/m\hat{ }2 of the formaldehyde-scavenging formulation, of which 0.5-20 g/m\hat{ }2 is formaldehyde scavenger.

### Construction Products

Also provided according to the present invention is a construction product having (i.e. including/comprising) a non-woven veil according to the present invention on at least one surface.

In certain embodiments, the construction product is selected from the group consisting of: a ceiling tile, a wall panel, an insulation board, a gypsum board, and a wood based panel. In certain embodiments, the construction product is selected from the group consisting of: a ceiling tile, a wall panel, an insulation board, and a wood based panel

In particular, the construction product may have a non-woven veil according to the present invention on at least one of a front face and a back face.

In certain embodiment, the construction produce is made of a wool selected from the group consisting of: glass wool, rock wool, stone wool and mineral wool.

Products including wood based panels include, but are not limited to, floor tiles and furniture. Ceiling tiles include, but are not limited to, wet felt boards.

In the case of a ceiling tile, it may have a non-woven veil according to the present invention on at least one of its front and back faces. The ceiling tile may contain a formaldehyde emissive binder. The ceiling tile may be made of wool. The wool may be a glass, rock, stone or mineral wool.

In the case of a wall panel, it may have a non-woven veil according to the present invention on at least one of its front and back faces. The wall panel may contain a formaldehyde emissive binder. The ceiling tile may be made of wool. The wool may be a glass, rock, stone or mineral wool.

In the case of an insulation board, it may have a non-woven veil according to the present invention on at least one of its front and back faces. The insulation board may be a phenolic foam board, or a mineral wool board.

In the case of a wood based panel (WBP), it may have a non-woven veil according to the present invention on at least one of its front and back faces, or contained in a laminate.

Also provided according to the present invention is a method of reducing formaldehyde emissions from a construction product, the method comprising the step of attaching a non-woven veil according to the present invention to at least one outer surface of the construction product. As previously discussed, in certain embodiments the construction product is selected from the group consisting of: a ceiling tile, a wall panel, an insulation board, and a wood based panel.

The at least one outer surface may be an at least one major surface of the product, for example a front surface, or both a front surface and a rear surface. Examples of construction products are tiles (for example, ceiling tiles) and panels and boards (for example, wall panels, ceiling panels, and insulation boards).

Particular and preferred aspects of the invention are set out in the accompanying independent claims. Combinations of features from the dependent claims may be combined with features of the independent claims as desired and appropriate and not merely as explicitly set out in the claims. The term “comprising” as used herein to specify the inclusion of components also includes embodiments in which no further components are present.

Embodiments of the invention will now be described, by way of example only.

### DETAILED DESCRIPTION

The % by weight values used throughout the specification are based on the total dry weight.

In the following examples, formaldehyde-scavenging formulations and construction products according to the present invention show excellent results.

Agglomeration was measured with filter over a fine mesh. The formulation is entering into a tank while running through fine mesh filter. This filter can catch larger particles (agglomerates) and if these build up they can block the filter. We have considered “no agglomeration” if the filter is not blocked after 8 h of running the formulation through the fine mesh filter.

Production of the formulation of Example 1 does not result in agglomeration.

Similarly, production of the formulations of Example 2 and Example 3 does not result in agglomeration.

### Example 1

| Component | Solids (%) | Kg wet | % dry |
|---|---|---|---|
| Water | | 1977 | |
| Formaldehyde scavenger | 21.0% | 636 | 10.26% |
| (polyvinylamine) | | | |
| Non-ionic binder (self-crosslinking | 55.0% | 205 | 8.66% |
| dispersion of Vinyl Acetate | | | |
| Ethylene (VAE)) | | | |
| Non-ionic ATH fire retardant slurry | 64.0% | 1412 | 69.51% |
| Antifoaming agent (non-ionic) | 0.5% | 424 | 0.16% |
| Repellent (non-fluorinated cationic | 30.0% | 282 | 6.52% |
| water emulsion) | | | |
| Aminosilane | 20% | 64 | 4.89% |
| Total | | 5000 | 100.00% |

This formulation gives a wet mass of 5000 kg including components having a dry weight of 1300 kg.

There was no observed agglomeration of the formulation in production machinery. The formulation was added to a non-woven veil at 45 g/m\hat{ }2 (i.e. 4.62 g/m\hat{ }2 PVAm formaldehyde scavenger).

A separate formulation with anionic stabilised ATH (instead of non-ionic ATH) results in agglomeration.

A separate formulation with anionic binder (instead of non-ionic binder) results in agglomeration.

Example 2

| Component | Solids (%) | Kg wet | % dry |
|---|---|---|---|
| Water | | 3933 | |
| Formaldehyde scavenger | 21.0% | 1049 | 97.95% |
| (polyvinylamine) | | | |
| Antifoaming agent (non-ionic) | 0.5% | 6 | 0.01% |
| Pigment | 35.0% | 13 | 2.04% |
| Total | | 5000 | 100.00% |

This formulation gives a wet mass of 5000 kg including components having a dry weight of 1067 kg.

Agglomeration does not occur with this formulation. The formulation is added to a non-woven veil at 5 g/m\hat{ }2 (i.e. 4.90 g/m\hat{ }2 PVAm formaldehyde scavenger).

A separate formulation with anionic antifoaming agent (instead of non-ionic antifoaming agent) results in agglomeration.

Example 3

| Component | Solids (%) | Kg wet | % dry |
|---|---|---|---|
| Water | | 2911 | |
| Formaldehyde scavenger | 21.0% | 1099 | 27.15% |
| (polyvinylamine) | | | |
| Non-ionic ATH fire retardant slurry | 64.0% | 952 | 71.71% |
| Antifoaming agent (non-ionic) | 0.5% | 10 | 0.01% |
| Pigment | 35.0% | 27 | 1.13% |
| Total | | 5000 | 100.00% |

This formulation gives a wet mass of 5000 kg including components having a dry weight of 850 kg.

Agglomeration does not occur with this formulation. The formulation is added to a non-woven veil at 18 g/m\hat{ }2 (i.e. 4.89 g/m\hat{ }2 PVAm formaldehyde scavenger).

A separate formulation with anionic stabilised ATH results in agglomeration.

### Conclusions

The Example 1 formulation does not result in agglomeration. Similarly, the formulations of Example 2 and Example 3 do not result in agglomeration.

Various modifications and variations to the described embodiments of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes of carrying out the invention which are obvious to those skilled in the art are intended to be covered by the present invention.

1. A formaldehyde-scavenging formulation comprising:
(a) a polyvinylamine (PVAm) formaldehyde scavenger or a copolymer thereof;
(b) optionally a non-ionic or cationic stabilized binder and/or crosslinker; and
(c) a non-ionic stabilized fire retardant.

2. A formaldehyde-scavenging formulation according to claim 1, comprising:
(a) 1 to 90% by weight dry mass of the polyvinylamine (PVAm) formaldehyde scavenger or a copolymer thereof;
(b) 1 to 60% by weight dry mass of the non-ionic or cationic stabilized binder and/or crosslinker; and
(c) 10 to 90% of the non-ionic stabilized fire retardant.

3. A formaldehyde-scavenging formulation according to claim 1, wherein the non-ionic or cationic stabilized binder and/or crosslinker is a non-ionic stabilized binder.

4. A formaldehyde-scavenging formulation according to claim 1, wherein the non-ionic stabilized fire retardant is non-ionic stabilized aluminium trihydrate (ATH) (Al(OH)₃) slurry or dispersion.

5. A formaldehyde-scavenging formulation according to claim 1, additionally comprising base in an amount of less than or equal to 50% by weight dry mass.

6. A formaldehyde-scavenging formulation according to claim 5, wherein the base is present in an amount of 0.5-25% by weight dry mass.

7. A formaldehyde-scavenging formulation according to claim 1, additionally comprising antifoaming agent in an amount below of less than or equal to 1.5% by weight dry mass.

8. A formaldehyde-scavenging formulation according to any of the preceding claims, claim 1, additionally comprising repellent agent in an amount below or of less than or equal to 20% by weight dry mass.

9. A formaldehyde-scavenging formulation according to claim 1, additionally comprising at least one of:
(A) dispersing agent;
(B) viscosity modifier; and
(C) polyphosphate sodium salts —[MPO₃]—ₙ(OH)₂ wherein M is selected from the group consisting of Na, K, and NH₄, and wherein n is an integer greater than 100.

10. A formaldehyde-scavenging formulation according to claim 1, additionally comprising a pigment.

11. A formaldehyde-scavenging formulation according to claim 1, wherein the formulation is an aqueous formulation.

12. A formaldehyde-scavenging formulation comprising:
a polyvinylamine (PVAm) formaldehyde scavenger;
a non-ionic stabilized binder and/or crosslinker; and
a non-ionic stabilized aluminium trihydrate (ATH) fire retardant;
an antifoaming agent;
a repellent agent; and
an aminosilane.

13. A formaldehyde-scavenging formulation according to claim 12, wherein the polyvinylamine (PVAm) has a weight average molecular weight (Mw) in the range 50,000-800,000 g/mol.

14. A non-woven veil coated with or containing a formaldehyde-scavenging formulation according to claim 12.

15. A non-woven veil according to claim 14, wherein the veil is a glass fibre non-woven veil.

16. A construction product having a non-woven veil according to claim 15 on at least one surface.

17. A construction product according to claim 16, wherein the construction product is made of a wool selected from the group consisting of: glass wool, rock wool, stone wool and mineral wool.

18. A construction product according to claim 17, wherein it is selected from the group consisting of: a ceiling tile, a wall panel, an insulation board, and a wood based panel.

19. A method of reducing formaldehyde emissions from a construction product, the method comprising the step of attaching a non-woven veil according to claim 14 to at least one outer surface of the construction product.

20. The formaldehyde-scavenging formulation of claim 12, wherein the formulation comprises:
from 1 to 90% by weight dry mass of the polyvinylamine (PVAm) formaldehyde scavenger;
less than or equal to 60% by weight dry mass of the non-ionic stabilized binder and/or crosslinker;
less than or equal to 96% by weight dry mass of the non-ionic stabilized aluminium trihydrate (ATH) fire retardant;
less than or equal to 1% by weight dry mass of the antifoaming agent; and
less than or equal to 20% by weight dry mass of the repellant agent.
